(19) United States
(12) Patent Application Publication
(10) Pub. No.: US 2023/0156257 A1
(43) Pub. Date: May 18, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Toru Suneya, Kanagawa (JP)

(21) Appl. No.: 18/054,067

(22) Filed: Nov. 9, 2022

(30) Foreign Application Priority Data
Nov. 12, 2021 (JP) 2021-184747

(51) Int. Cl. H04N 21/262; H04N 21/2343; H04N 21/431

(52) U.S. Cl. CPC H04N 21/26258; H04N 21/23439; H04N 21/4312

(57) ABSTRACT

There is provided with an information processing apparatus. A playlist generation unit generates a playlist including a URL (Uniform Resource Locator) for acquiring media data. A transmission unit transmits the media data and the playlist. The playlist includes at least one of transformation process information which indicates one or more transformation processes to be applied to the media data, and one or more layout information for spatially arranging the media data.

### BACKGROUND OF THE DISCLOSURE

### Field of the Disclosure

The present disclosure relates to an information processing apparatus, an information processing method, and a storage medium.

### Description of the Related Art

In recent years, MPEG-DASH, which was standardized in MPEG under the umbrella of the ISO and IEC, has become widely used as a technology for streaming and transmitting media data such as video (images) and audio via HTTP. ISO is an abbreviation for International Organization for Standardization and IEC is an abbreviation for International Electrotechnical Commission. MPEG-DASH is an abbreviation for Moving Picture Experts Group-Dynamic Adaptive Streaming over HTTP.

In MPEG-DASH, media data is divided into segments of a predetermined time length, and URLs (Uniform Resource Locator) for acquiring the segments are described in a file called a playlist. A reception apparatus first acquires the playlist, and makes a request to a transmission apparatus in order to acquire a desired segment by using information described in the playlist. Furthermore, URLs for multiple versions of segments having different bit rates, resolutions, and the like may be described in the playlist, and in such cases, the reception apparatus can acquire an optimal version of a segment according to its own capabilities, communication environment, and the like.

Japanese Patent Laid-Open No. 2011-172255 discloses a technique for adding, to a video sequence, metadata for dynamically overlaying one or more video streams. It is described that metadata includes overlay parameters, and preferably includes information about geometric conditions of the display of the video stream (enlargement/reduction, transparency, rotation, inversion, cropping). In addition, it is described that the metadata may be in the form of a playlist (.mpls) or a DVD “.ifo” file.

### SUMMARY OF THE DISCLOSURE

According to one embodiment of the present disclosure, an information processing apparatus, comprises: a playlist generation unit configured to generate a playlist including a URL (Uniform Resource Locator) for acquiring media data; a transmission unit configured to transmit the media data and the playlist, wherein the playlist includes at least one of transformation process information which indicates one or more transformation processes to be applied to the media data, and one or more layout information for spatially arranging the media data.

According to another embodiment of the present disclosure, an information processing apparatus, comprises: a playlist generation unit configured to generate a playlist including a URL (Uniform Resource Locator) for acquiring media data; and a transmission unit configured to transmit the media data and the playlist, wherein URLs for acquiring a plurality of media data are described in the playlist, and among the plurality of media data, content of first media data is a derived operation corresponding to second media data, the playlist includes information indicating that the first media data is a derived operation of another media data and information for identifying that a target of a derived operation of the first media data is the second media data, the derived operation includes at least one of transformation process information indicating one or more transformation processes to be applied to the second media data and one or more layout information for spatially arranging the second media data.

According to still another embodiment of the present disclosure, an information processing apparatus, comprises: a playlist acquisition unit configured to acquire a playlist including a URL (Uniform Resource Locator) for acquiring media data; and a playlist analysis unit configured to analyze the playlist; a reception unit configured to receive the media data by using a result of the analysis of the playlist, wherein in a case where the playlist includes transformation process information indicating one or more transformation processes to be applied to the received media data, when outputting the received media data, the transformation processes indicated in the transformation process information is applied to the media data.

According to yet another embodiment of the present disclosure, the information processing apparatus, comprises: a playlist acquisition unit configured to acquire a playlist including a URL (Uniform Resource Locator) for acquiring media data; a playlist analysis unit configured to analyze the playlist; a reception unit configured to receive the media data by using a result of the analysis of the playlist, wherein in a case where the playlist includes one or more layout information for spatially arranging one or more media data and there are a plurality of layout information, one layout information is applied to the media data when the received media data is outputted.

Further features of the present disclosure will become apparent from the following description of exemplary embodiments (with reference to the attached drawings).

### BRIEF DESCRIPTION OF THE DRAWINGS

FIG. 1 is a diagram illustrating a system configuration of an embodiment.

FIG. 2 is a block diagram illustrating a functional configuration of a transmission apparatus.

FIG. 3A and FIG. 3B are explanatory views of a configuration of an HEIF file and a derived image construction.

FIG. 4 is an explanatory view of an ISOBMFF file configuration and output data generation.

FIG. 5 is a flowchart from HEIF file analysis to playlist generation.

FIGS. 6A and 6B are a diagram showing an example of a description in a case of a layout display of an HEIF file.

FIGS. 7A and 7B are a diagram illustrating an example of a description in a case of performing transformation processing on a moving image and audio.

FIG. 8 is a diagram illustrating an example of a description for streaming a sample of a derived track.

FIG. 9A-C are diagrams illustrating an example of a description in which a plurality of layout information is defined so as to be selectable.

FIG. 10 is a block diagram illustrating a functional configuration of a reception apparatus.

FIG. 11 is a flowchart from acquisition of a playlist to reproduction of an item.

### DESCRIPTION OF THE EMBODIMENTS

Hereinafter, embodiments will be described in detail with reference to the attached drawings. Note, the following embodiments are not intended to limit the scope of the present disclosure. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

As described above, in MPEG-DASH, a URL for acquiring a segment and a URL relating to a bit rate, a resolution, and the like may be described in the playlist. However, in MPEG-DASH, it is not possible to realize transformation processing such as enlargement/reduction/rotation, a layout display, and the like for a segment that is transmitted by streaming. With the technique described in Japanese Patent Laid-Open No. 2011-172255, it is possible to describe, in a playlist, metadata for performing a geometric transformation on a video and to perform an overlay-display. However, even with the technique described in Japanese Patent Laid-Open No. 2011-172255, it is similarly not possible to realize a transformation process such as enlargement/reduction/rotation and a layout-display for a streamed segment.

Therefore, an embodiment of the present disclosure provides an information processing apparatus for enabling transformation processing such as enlargement/reduction/rotation and layout-display for a streamed segment.

### First Embodiment

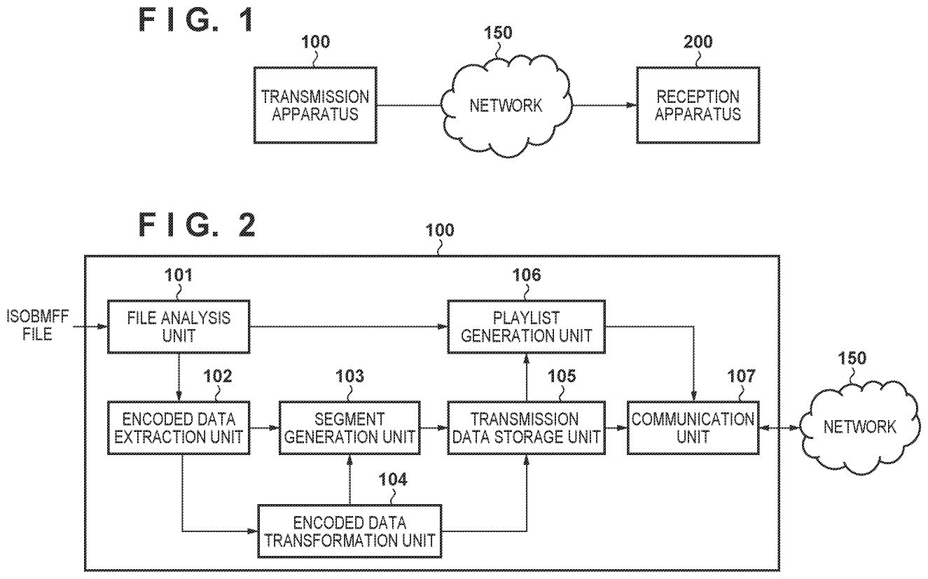

FIG. 1 is a diagram illustrating an example of an overall configuration of a system according to a first embodiment. A transmission apparatus 100 is connected to a reception apparatus 200 via a network 150. Incidentally, there may be multiple instances of each of the transmission apparatus 100 and the reception apparatus 200.

Examples of the transmission apparatus 100 include information processing apparatuses such as a camera apparatus, a video camera apparatus, a smartphone apparatus, a mobile phone, a PC apparatus, and a cloud server apparatus, but the present disclosure is not limited to these examples as long as the functional configuration according to the present embodiment described later is satisfied.

The reception apparatus 200 has a function of reproducing and displaying content, a communication function, and a function of receiving input from a user. Examples of the reception apparatus 200 include information processing apparatuses such as a smartphone apparatus, a mobile phone, a PC apparatus, and a television set, but the present disclosure is not limited to these examples as long as the information processing apparatus has a function to be described later.

The network 150 may be, for example, a wired LAN (Local Area Network) or a wireless LAN (Wireless LAN), but is not limited thereto. For example, the network 150 may be a WAN (Wide Area Network) such as the Internet or so-called 3G/4G/LTE/5G; an ad hoc network; Bluetooth (registered trademark), or the like.

FIG. 2 is a block diagram illustrating a functional configuration of the transmission apparatus 100. The transmission apparatus 100 according to the present embodiment is an apparatus capable of generating a playlist for enabling a transformation process such as enlargement/reduction or rotation on media data or a layout display at the time of streaming reproduction when streaming media data using an HTTP protocol.

As illustrated in FIG. 2, the transmission apparatus 100 includes a file analysis unit 101, an encoded data extraction unit 102, a segment generation unit 103, an encoded data transformation unit 104, a transmission data storage unit 105, a playlist generation unit 106, and a communication unit 107.

The file analysis unit 101 has a function of analyzing the configuration of a file of an ISO Base Media File Format (hereinafter referred to as ISOBMFF). ISOBMFF file will be described in detail later. The encoded data extraction unit 102 has a function of extracting encoded data stored in an ISOBMFF file based on the result of analysis of the ISOBMFF file by the file analysis unit 101.

The encoded data transformation unit 104 has a function of transforming the encoded data extracted by the encoded data extraction unit 102 into different encoding formats as necessary.

The segment generation unit 103 has a function of transforming the encoded data extracted by the encoded data extraction unit 102 into a time length or a bit rate suitable for communication as necessary, and generating a segment in which the encoded data is stored. The segment generation unit 103 also has a function of generating a segment in which encoded data transformed into different encoding formats by the encoded data transformation unit 104 is stored as necessary.

The transmission data storage unit 105 has a function of storing segment data generated by the segment generation unit 103 and encoded data transformed into different encoding formats as necessary by the encoded data transformation unit 104.

The playlist generation unit 106 has a function of generating a playlist describing URLs (Uniform Resource Locators) that allow data stored in the transmission data storage unit 105 to be accessed. In the present embodiment, the playlist generation unit 106 generates a playlist including URLs for acquiring media data based on the result of analysis of an ISOBMFF file by the file analysis unit 101.

The communication unit 107 has a function of transmitting the playlist generated by the playlist generation unit 106 and segments of the media data from the transmission data storage unit 105 to the reception apparatus 200 via the network 150 in response to a request from the reception apparatus 200. Detailed processing in the functional configuration of the reception apparatus 200 will be described later.

Next, ISOBMFF will be described. ISOBMFF is a segment file format that may be used in MPEG-DASH (Moving Picture Experts Group-Dynamic Adaptive Streaming over HTTP). An ISOBMFF configuration is roughly divided into a part for storing header information and a part for storing encoded data. The header information includes information indicating the size of the encoded data stored in the segment and a time stamp, and the encoded data may store a moving image, a still image, audio, text, and the like.

In ISOBMFF, there are a plurality of enhanced standards that depend on the type of encoded data to be stored. For example, a specification for storing still images and image sequences encoded by HEVC, which is mainly a codec for moving images, is standardized as ISO/IEC 23008-12 (Part 12) under the name of Image File Format. Note that HEVC is an abbreviation for High Efficiency Video Coding. ISO/IEC 23008-12 is commonly referred to as HEIF (High Efficiency Image File Format). In HEIF, it is possible to set a property for executing a transformation process such as enlargement/reduction/rotation at the time of reproduction to a still image stored in a file.

Meanwhile, standardization of derived visual tracks in the ISO base media file format is underway in ISO/IEC 23001-16 (Part 16) as a codec-independent ISOBMFF derivation standard. Hereinafter, derived visual tracks in the ISO base media file format is referred to as derived visual tracks in the present embodiment and abbreviated as Dvt. Dvt (derived visual tracks) is a standard for performing a transformation process such as enlargement/reduction/rotation when reproducing image (video) data.

In addition, in ISOBMFF, a plurality of media data may be stored in one file, but in HEIF and the Dvt, layout information for when a plurality of stored media are to be displayed on the same screen may be stored as metadata. A plurality of media thus constructed are outputted as what is called a derived image in the case of a still image, and what is called a derived track in the case of a moving image.

As described above, in MPEG-DASH, ISOBMFF may be used as a file format for media to be streamed. However, the current MPEG-DASH does not consider describing information for executing a transformation process such as enlargement/reduction/rotation when the media data is reproduced, or media data layout information in a playlist. Accordingly, in the current MPEG-DASH, it is not possible to convey information for transformation processing such as enlargement/reduction/rotation, a layout display, or the like for media data that is transmitted by streaming. Further, in MPEG-DASH, since it is desirable to select and acquire media data having a desired configuration at the receiving side, there may be a plurality of choices for transformation processes and the layout information, similarly to the bit rate, the resolution, and the like.

Hereinafter, a mechanism for displaying the still image data stored in an HEIF file, which is obtained by applying a transformation process such as enlargement/reduction/rotation or the like in accordance with predetermined layout information will be described.

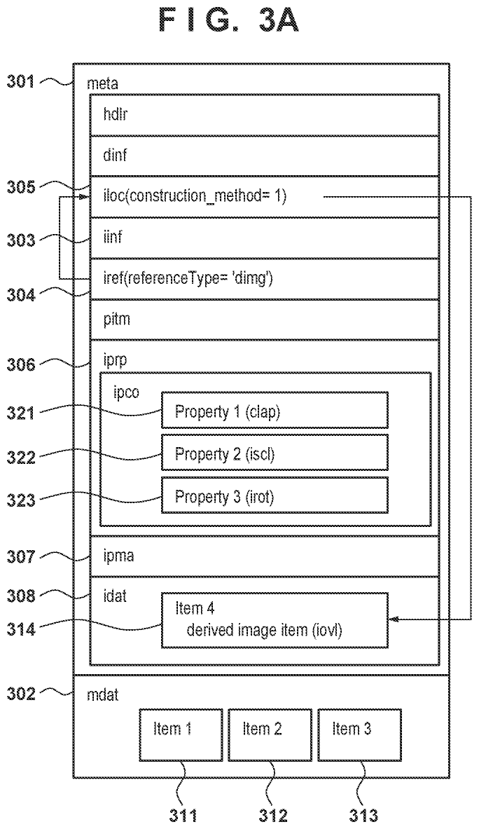

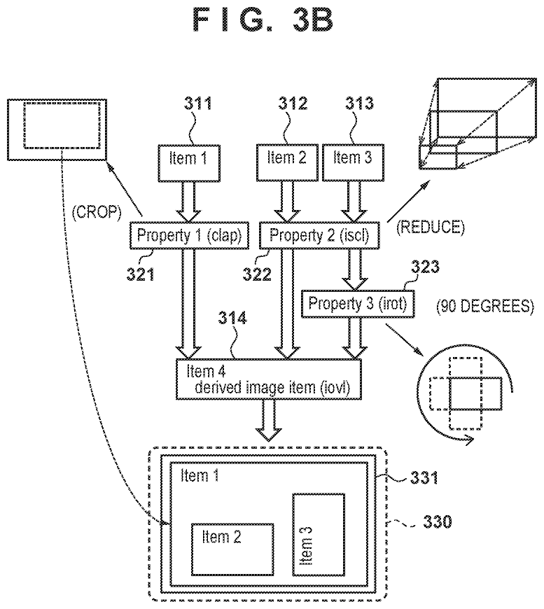

FIG. 3A and FIG. 3B are diagrams to be used for describing a mechanism for displaying the result of applying, to still image data stored in an HEIF file, a transformation process such as enlargement/reduction/rotation or the like, in accordance with predetermined layout information.

FIG. 3A is a schematic diagram illustrating a configuration of an HEIF file in which information related to a derived image is stored.

In FIG. 3A, a still image stored in an HEIF file is referred to as an item. The HEIF file includes meta 301 in which is stored so-called metadata such as encoding information of an item and a storage location of encoded data, and mdat 302 in which data of each of the items is stored. In the example of FIG. 3A, three items (Item 1 (311), Item 2 (312), and Item 3 (313)) are stored in mdat 302. Note that each of the rectangular regions denoted by four letters shown in FIG. 3A is a logical region called a box, and ISOBMFF and the respective derivative standards based on the ISOBMFF format are combined in a form in which boxes are nested.

Next, the role of each box will be described. Here, mainly information related to the present embodiment will be described.

meta 301 is made of boxes such as iinf 303, iref 304, iloc 305, iprp 306, ipma 307, and idat 308.

iinf 303 stores an identifier for identifying the stored item, information indicating the type of the item, and the like. Note that items other than still images may be included, and for example, Exif data generated when a still image is captured by a digital camera or the like, layout information for displaying a plurality of items in combination, and the like may also be stored as items.

In addition, iref 304 is a box in which information for associating related items is stored. In iref 304, for example, an association between a still image and Exif data; information associating layout information and items included in a layout; and the like are stored, and reference types corresponding to the association relationships between items are defined. For example, a dimg is defined for a type of association between items related to layout information of the latter.

iloc 305 is a box in which information indicating a position of an item stored in an HEIF file is stored, and a construction method which is information indicating a storage location is defined for each item. For example, when the reference type defined in iref 304 is dimg, “1”, which indicates that the storage location of the item is idat 308, is often defined as a construction method. In such a case, the item related to the layout information is stored in idat 308, and in the example of FIG. 3A, Item 4 (314) is an item that stores the layout information. It is assumed that Item 4 (314) has information for layout and display of three related items, Item 1 (311), Item 2 (312), and Item 3 (313) in an overlay.

In addition, iprp 306 stores item properties, and for example, stores information related to item encoding parameters, information indicating that an item is to be displayed after performing a transformation process such as enlargement/reduction/rotation, or the like. In the example of FIG. 3A, three properties (Property 1 (321), Property 2 (322), and Property 3 (323)) are stored in iprp 306. Property 1 (321) is information related to image cropping, Property 2 (322) is information related to image enlargement/reduction, and Property 3 (323) is information related to image rotation. Information associating these properties with items is stored in ipma 307. Here, it is assumed that Property 1 (321) is associated with Item 1 (311), Property 2 (322) is associated with Item 2 (312), and Property 2 (322) is associated with Item 3 (313) and Property 3 (323).

Next, a process for constructing an HEIF derived image will be described with reference to FIG. 3B. FIG. 3B is a schematic diagram of a mechanism for constructing a derived image using information stored in an HEIF file.

In FIG. 3B, Item 1 (311) applies Property 1 (321), which is an associated property, to generate an image in which a part of the original image is cropped. Similarly, Item 2 (312) applies Property 2 (322) to generate an image in which the original image is reduced. For Item 3 (313), first an image is generated by reducing the original image by applying Property 3 (322), and further rotates the reduced image by 90 degrees counterclockwise by applying Property 3 (323).

As described above, for Item 4 (314), information for displaying three items that are laid out in an overlay is stored. Here, an image obtained by cropping Item 1 (311) is arranged on the background image 331, and an image obtained by reducing Item 2 (312) and an image obtained by reducing and rotating Item 3 (313) are arranged side by side. In this way, a derived image 330 is generated. Note that the reduction and the angle of rotation of the image described here are merely examples.

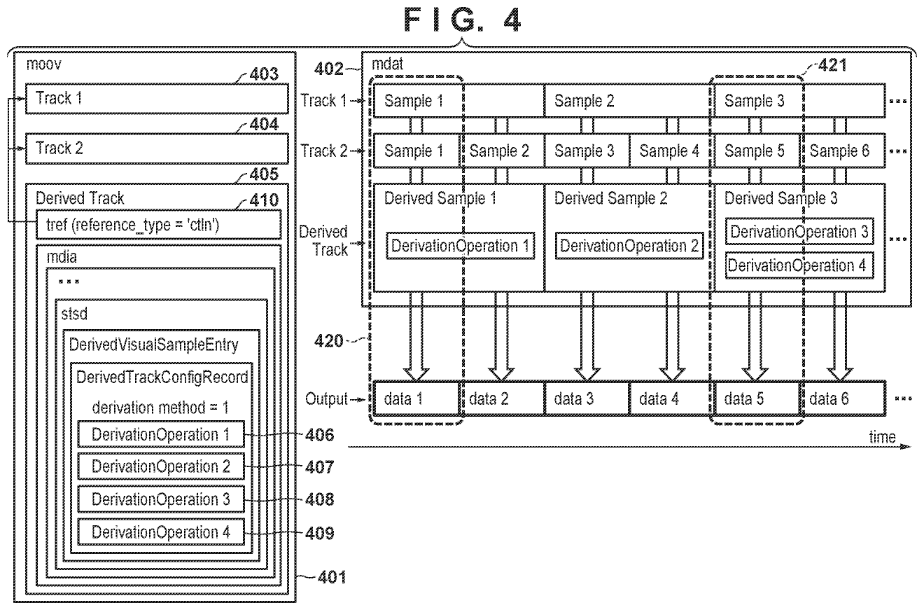

Next, a mechanism for applying, to the moving image data stored in ISOBMFF, a transformation process such as enlargement/reduction/rotation and then displaying will be described with reference to FIG. 4. FIG. 4 is a schematic diagram illustrating an ISOBMFF file configuration in which information related to a derived track is stored and a mechanism for generating output data.

In FIG. 4, ISOBMFF is composed of moov 401 which is a header region of a file and mdat 402 which is an encoded data region. In FIG. 4, moov 401 and mdat 402 are separately described for convenience of layout; however, they are usually generated in a state of being connected in one file.

moov 401 includes Track 1 (403) and Track 2 (404) which are tracks for managing video data and Derived Track 405 which is a derived track. Derived Track 405 stores the following four transformation process information indicating transformation processes such as enlargement/reduction/rotation to be applied to samples of videos managed in Track 1 (403) and Track 2 (404). That is, four transformation process information (Derivation Operation 1 (406), Derivation Operation 2 (407), Derivation Operation 3 (408), and Derivation Operation 4 (409)) are stored. Further, information identifying the track for managing the samples to which the transformation process information is to be applied is stored in a tref 410 which is a box for storing track reference information, and the reference type in this example is ctln. Note that a sample is a unit for handling encoded data of media in ISOBMFF, and when normal video is used, one frame is treated as one sample.

mdat 402 contains samples of two video tracks and one derived track. Output data is the result of applying Derivation Operation 1 (406), which is defined as a sample of the derived track, to the first sample of Track 1 (403) and the first sample of Track 2 (404), as illustrated in the region 420 surrounded by the dash lines. Thereafter, a stream of output data may be generated by proceeding with similar processing. Note that, as shown in the region 421 surrounded by the dotted line in FIG. 4, a plurality of transformation processes may be applied to the data of the video tracks.

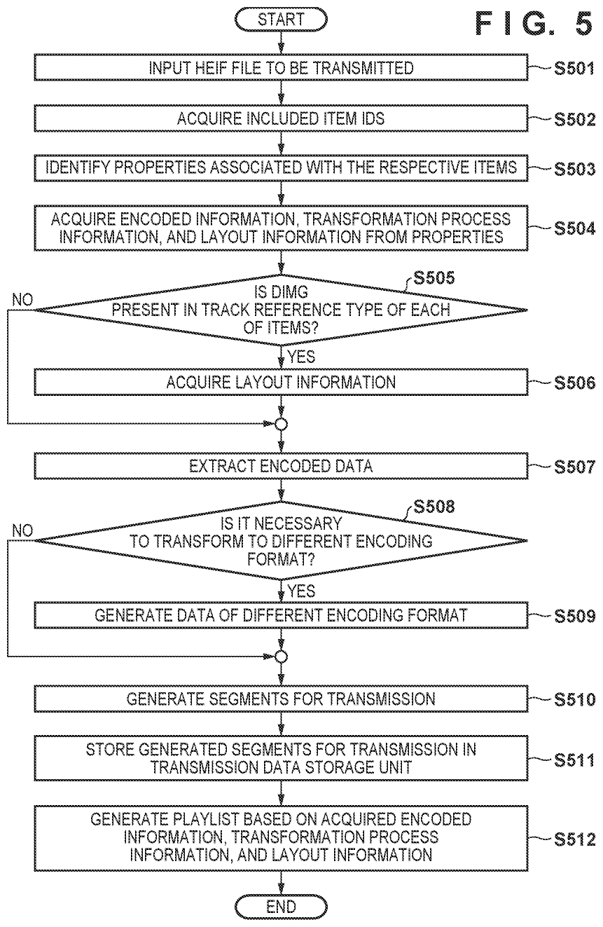

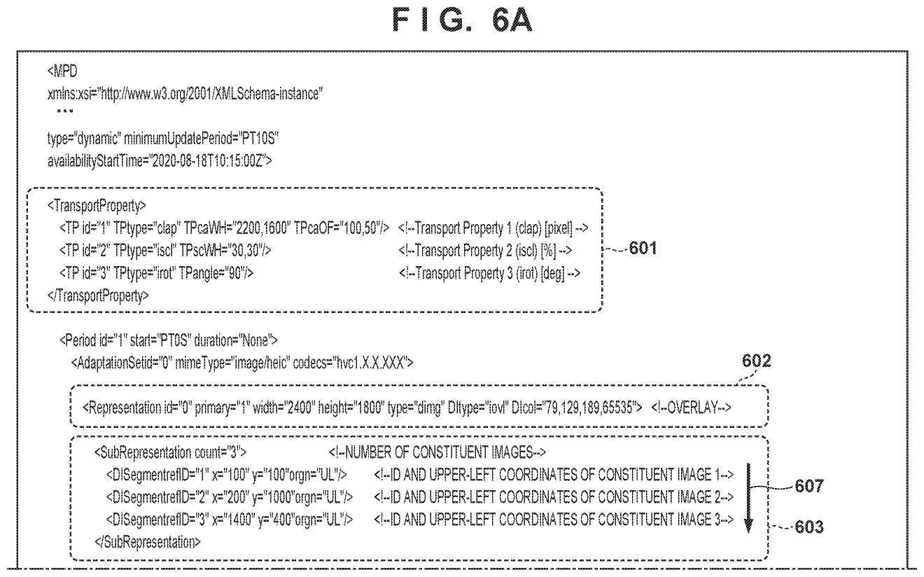

Next, a flow of processing for analyzing an HEIF file in the transmission apparatus 100 of the present embodiment and generating a segment and a playlist based on the result of the analysis will be described with reference to FIG. 5. FIG. 5 is a flowchart illustrating an exemplary HEIF file-analysis process performed by the transmission apparatus 100 according to the present embodiment. In MPEG-DASH, a file corresponding to a playlist is called an MPD (Media Presentation Description).

First, in step 5501 of FIG. 5, an HEIF file to be transmitted is inputted to a transmission apparatus. The HEIF file is then sent to the file analysis unit 101.

In the subsequent step 5502, the file analysis unit 101 acquires item IDs which are identifiers of the respective items included in the HEIF file.

Next, in step 5503, the file analysis unit 101 identifies properties associated with the respective items.

Further, in the step S504, the file analysis unit 101 acquires encoded information, transformation process information, and the layout information from the identified properties.

Then, the file analysis unit 101 checks whether a dimg is present in the track reference type of each of the items in the subsequent step S505, and acquires layout information in the subsequent step S506 if so. On the other hand, when there is no dimg in the track reference type, layout information is not stored, and therefore, the file analysis unit 101 does not perform the process of step S506. As described above, the analysis process and the process for acquiring the analyzed information from step S502 to step S506 are performed by the file analysis unit 101.

Next, in step S507, the encoded data extraction unit 102 extracts the encoded data stored in the HEIF file to be transmitted, based on the result of the analysis by the processing up to step S506.

Next, in step S508, the encoded data extraction unit 102 determines whether or not it is necessary to transform the encoding format of the encoded data extracted in step S507 into a different encoding format supported by many decoders in a case where it is supported by few decoders, example. When it is determined in step S508 that the encoding format needs to be transformed, the process in the transmission apparatus 100 proceeds to step S509. Meanwhile, when it is determined in step S508 that the encoding format does not need to be transformed, the process in the transmission apparatus 100 proceeds to step S510.

When the process proceeds to step S509, the encoded data transformation unit 104 re-encodes the encoded data extracted in step S507. As a result, data of a different encoding format is generated. After step S509, the process in the transmission apparatus 100 proceeds to step S510.

When the process proceeds to step S510, the segment generation unit 103 generates all or a part of the encoded data extracted in step S507 and the encoded data re-encoded in step S509 as segments that may be individually acquired by streaming transmission. For example, it is assumed that there are a plurality of encoded data extracted from an HEIF file and encoded data whose encoding format is transformed, and that the encoded data are still images. In this case, the segment generation unit 103, for each of the still image items, generates a file storing only one still image item in a single HEIF file.

Next, in step S511, the transmission data storage unit 105 stores the segments generated in step S510.

Then, in the final step S512, the playlist generation unit 106 generates a playlist based on the acquired encoded information, the transformation process information, and the layout information.

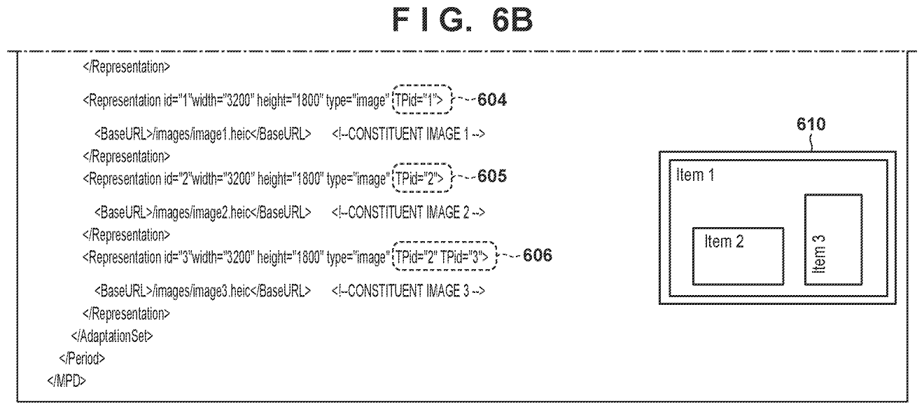

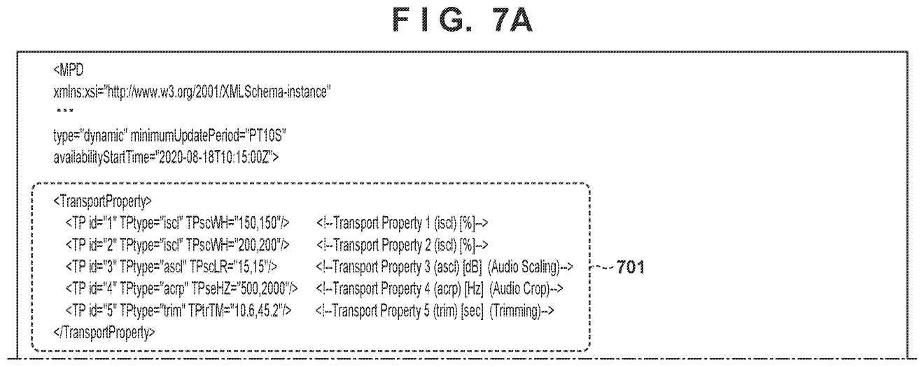

Next, an example of a playlist generated by the transmission apparatus 100 of the present embodiment will be described with reference to FIGS. 6A and 6B. FIGS. 6A and 6B are an example of a playlist generated by the transmission apparatus 100, and in particular it is an example of a description in a case where the HEIF file described with reference to FIG. 3A and FIG. 3B is layout-displayed.

The playlist illustrated in FIGS. 6A and 6B shows a part of an MPD in a case of transmitting by MPEG-DASH, and describes transformation process information representing transformation processing and layout information for layout-display in an overlay for three still image items. Although FIGS. 6A and 6B illustrate an example in which transformation process information and layout information are described, it may be that only one of these is described.

In FIG. 6A, a transformation property 601 is a property including transformation process information, and in FIG. 6A, three properties are described by TP tags. The TP tags include an identifier for identifying the respective transformation property, a transformation type indicating the type of transformation process, and parameters for each transformation type.

In the example of FIG. 6A, in the first transformation property, the identifier (id) is 1; the transformation type (TPtype) is clap (clean aperture), that is, a cropping process for extracting a part of the image; and two types of parameters (TPcaWH and TPcaOF) are described. The first parameter TPcaWH is a value of a width and a height of a region to be extracted from the image, and the second parameter TPcaOF is a value indicating a position to be cut out, specifically, a value indicating offsets in a rightward direction and a downward direction using the upper left of the original image from which the region is to be extracted as the origin.

Similarly, in the second transformation property, the identifier (id) is 2; the transformation type (TPtype) is iscl (image scaling), that is, an enlargement/reduction process; and the parameter TPscWH indicates enlargement/reduction ratios for the width and height as percentages.

In the third transformation property, the identifier (id) is 3; the transformation type (TPtype) is irot (image rotation), that is, an image rotation process; and the parameter TPangle indicates an angle of rotation. Note that the direction of rotation may be defined as a fixed direction in advance, or a flag indicating the rotation direction or the like may be added as a parameter of irot.

The transformation property 601 adds transformation processing by describing segment attribute information. That is, as described in segment attributes 604, 605, 606 in FIG. 6B, the identifier of the transformation property is described as TPid in the attribute information of the segment to which the transformation process is to be applied. That is, the transformation process information is defined as attribute information of the media data.

When identifiers of a plurality of transformation properties are described as in the segment attribute 606, transformation processing is performed in the order of description. That is, when a plurality of transformation processes are applied to a single media data, transformation process information representing the transformation process is described in the playlist in the order in which the transformation process is to be applied.

In FIG. 6A, the layout information is defined by two information: layout information 1 (602) and layout information 2 (603). The layout information 1 (602) indicates a Representation for a layout-display, by setting the type (“type”) attribute information of the Representation to dimg. The layout method is indicated in DItype, and iovl indicates an image overlay, specifically a still image overlay-display. In addition, DIcol indicates the background color of the region of the overlay-display. In FIG. 6A, four values (79, 129, 189, and 65535) are described; the three values from the beginning are respectively R, G, and B color information where the values range from 0 to 255, and the fourth value indicates transparency (0 is transparent and 65535 is opaque).

The layout information 2 (603) defines the number of segments and coordinate information of the segments to be displayed in the layout. That is, the numerical value 3 described in the count (“count”) of the layout information 2 (603) indicates that three segments are to be displayed in the layout. refID described in the DISegment tags indicates an identifier (a Representation id) of the segment to be displayed in the layout, and the coordinates in the layout are indicated by the three numerical values of x, y, and orgn. x and y denote vertical and horizontal coordinates at which the respective segment is to be displayed, and orgn indicates the position of the origin for the segment of these coordinates. In other words, when the upper left of the Representation serving as the background of the layout-display is set as the origin, orgn indicates the origin position of the segment for when indicating the display position of the respective segment, and the UL described in FIG. 6A indicates Upper Left, that is, the origin of the segment is also the upper left. That is, the positional relationship from the upper left of the background to the upper left of the segment is indicated by the coordinates of x and y. Note that the x and y coordinates may be expressed as offset values.

The description order of the DISegment tags of the constituent elements in the overlay-display may indicate the overlay order of the layers. That is, in the case where the layout information is information for an overlay-display of a plurality of media data, the overlay order of the layer-display may be indicated by the description order of the media data to be overlaid. In FIGS. 6A and 6B, the three segments that are components of the overlay correspond to the three items (Item 1, Item 2, and Item 3) described in FIG. 3B in Representation id order. Item 1, Item 2, and Item 3 are displayed as layer images; Item 1 is the layer directly above the background, Item 2 is displayed as the layer above Item 1, and Item 3 is similarly the layer above Item1 and Item2. This makes it possible to display the image in a layout such as the output image 610 of FIG. 6B.

In FIG. 6A, the arrow 607 indicates an order proceeding towards the upper layer, but the order may be oppositely described and proceed towards the lower layer. Further, configuration may be taken so that a numerical value indicating the layer (for example, a higher numerical value indicating a higher layer or a lower layer, and the same value indicating the same layer) is described as an attribute value of the respective DISegment tags.

Further, it is goes without saying that the description indicating the layout display is applicable even if the media is a moving image. Further, since the layout information may describe different layout information for each Period, the layout may be dynamically changed according to the reproduction time.

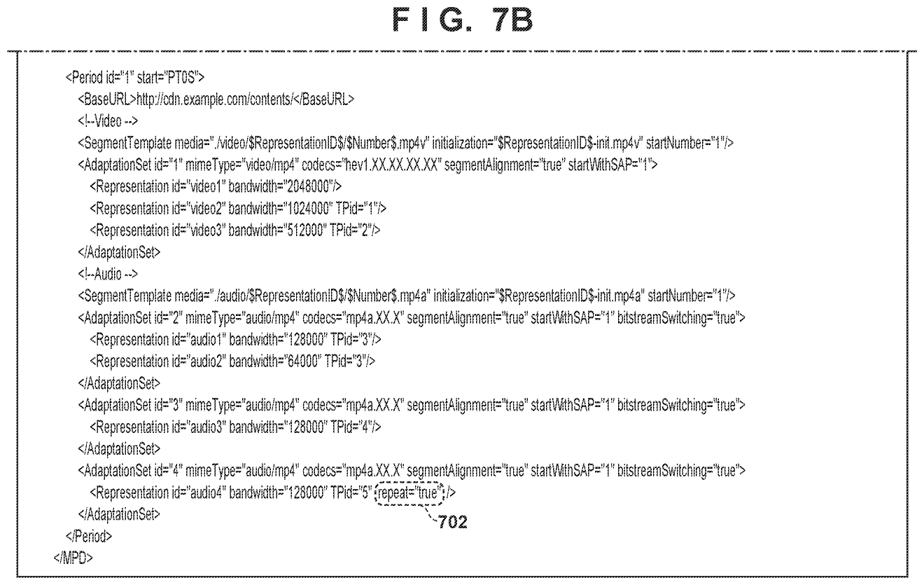

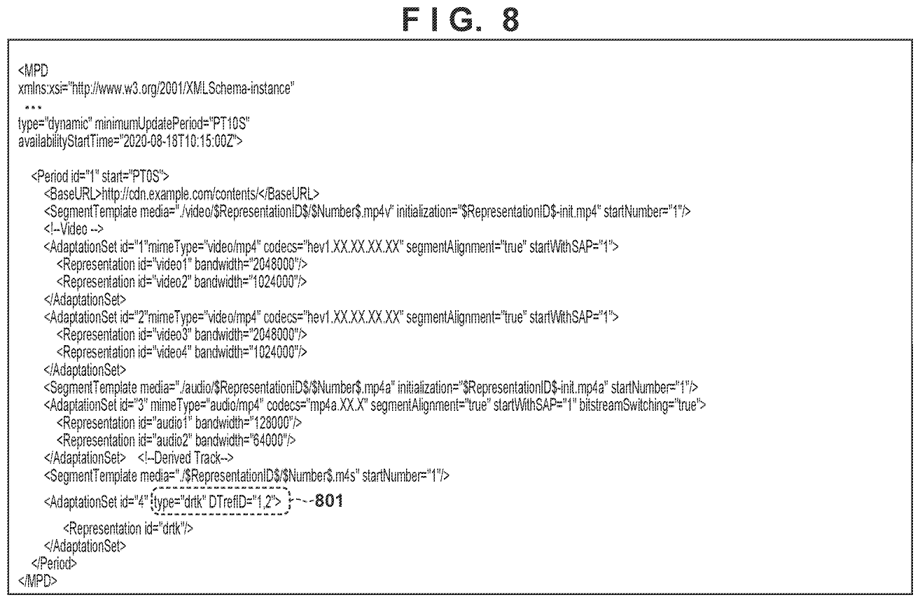

Next, an example of a moving image and audio playlist generated by the transmission apparatus of the present embodiment will be described with reference to FIGS. 7A and 6B. FIGS. 7A and 6B illustrate an example of a playlist generated in the transmission apparatus of the present embodiment, and in particular is an example of a description in a case where transformation processing is performed on a moving image and audio.

The playlist shown in FIGS. 7A and 6B show a part of an MPD transmitted by MPEG-DASH, and transformation processes are applied to moving images and audio. In the transformation property 701 of FIG. 7A, five transformation processes are defined, and two identifiers (“id”) 1 and 2 are iscl which indicates that the transformation type (TPtype) is enlargement/reduction, and these are similar to those described in FIG. 6B. Although a moving image is given as an example here, the transformation process is also applicable to a still image. That is, when the media data is a still image or a moving image, the transformation process information may be information indicating that geometric transformation processing such as enlargement, reduction, or rotation is performed on the media data.

The transformation type (TPtype) with the identifier (“id”) of 3 is ascl (audio scaling) and indicates the loudness of the audio, i.e. the sound pressure or the volume. The transformation type parameter TPscLR indicates the sound pressure or the volume for each of the left and right channels for stereo audio. That is, when the media data is audio data, the transformation process information may be information indicating that the volume or the sound pressure of the media data (audio data) is changed.

A transformation type (TPtype) with the identifier (id) of 4 is acrp (audio crop), and indicates that a specific frequency band that is part of the audio frequency band is to be extracted. The parameter TPseHZ of the transformation type indicates a lower limit and an upper limit of the frequency band to be extracted. That is, when the media data is audio data, the transformation process information may be information indicating that a part or the frequency band of the media data (audio data) is to be extracted.

The transformation type (TPtype) with the identifier (“id”) of 5 is trim, and is for cutting out a part on the time axis of timed media having temporal data. The parameter TPtrTM of this transformation type indicates the beginning and end times of the part to cut out of the media data. That is, in a case where the media data is timed media having temporal data, the transformation process information may be information indicating that a part of the section on the time axis of the media data is to be extracted.

In order to apply these transformation properties 701 to the media, identifiers of the transformation properties may be added as attribute information to AdaptationSet and Representation tags of the media to which they are to be applied, in a similar way to what was described with reference to FIGS. 6A and 6B. In addition, in a case where a plurality of transformation processes are to be performed overlappingly, the identifiers of desired transformation properties may be described side by side as described in FIGS. 6A and 6B.

In a case where a part on the time axis is to be cut out by applying the transformation type trim to the audio, or the like, when the reproduction time of the extracted media is shorter than the time length of Period in which the media is described, it may be desirable to repeatedly reproduce audio data as background music. Therefore, in FIG. 7B, a repetition attribute 702 indicating repetitive reproduction in a case where the segment reproduction time is shorter than Period is described. The repetition attribute 702 may be described as attribute information of Representation or AdaptationSet with repeat=“true” as in FIG. 7B. This repetition attribute may be applied to media other than audio data in the case of timed media having temporal data. That is, when the media data is timed media, the reproduction period for each media data is designated in the playlist and the reproduction time of the media data is shorter than the reproduction period, the transformation process information may be information indicating that the reproduction of media data is repeated in the reproduction period.

### Second Embodiment

Next, as a second embodiment, a method of transmitting, as is, a sample of a derived track described in FIG. 4 as a segment will be described with reference to FIG. 8. FIG. 8 is an example of a playlist generated in the transmission apparatus of the present embodiment, and in particular is an example of a description of a case where derived track samples are streamed. Note that the functional configuration of the transmission apparatus is similar to that of FIG. 2, and thus the illustration and description pertaining to same functions are omitted.

In FIG. 8, a segment includes two moving images, one audio, and one derived track, and derived related information 801 is added as attribute information of the derived track, and data having different bit rates is prepared as each piece of media data.

In the derived related information 801, drtk, which is a type indicating that the content of the media is derived track data, is indicated, and the subsequent attribute DTrefID indicates identifiers for identifying the media associated with the derived transformations.

In the example of FIG. 8, AdaptationSet identifiers for two moving images are described as the media associated with the derived transformation. The derived track sample includes operation information indicating processing for transformation on two moving images, layout-display, and the like, and these transformation processes and layout-display are referred to as derived operations in ISOBMFF.

That is, in the second embodiment, URLs for acquiring a plurality of different media data, such as the first and second media data, are described in the playlist, and the content of the first media data is a derived operation with respect to the second media data. Further, in the case of the second embodiment, the playlist includes information indicating that the first media data is a derived operation of another media data, and information for identifying that the target of the derived operation of the first media data is the second media data. In a second embodiment, the derived operation includes at least one of transformation process information representing one or more transformation processes to be applied to the second media data and one or more layout information for spatially arranging the second media data.

### Third Embodiment

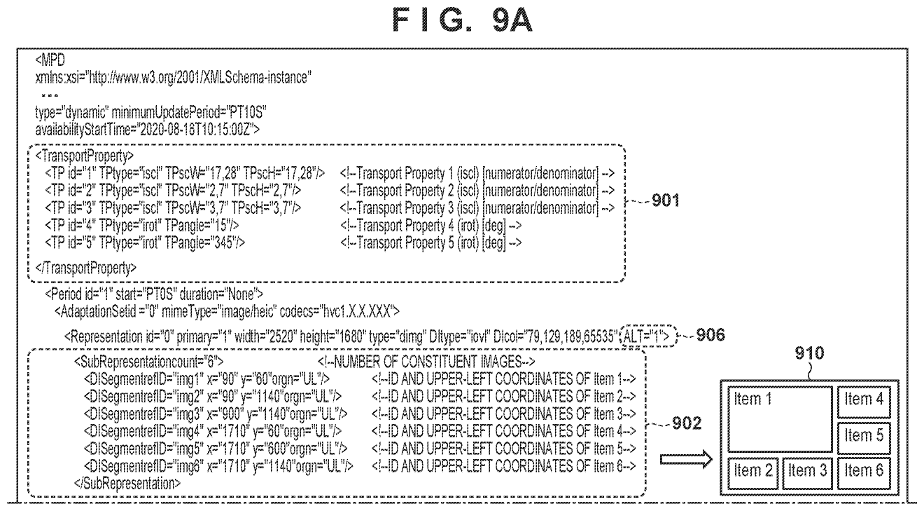

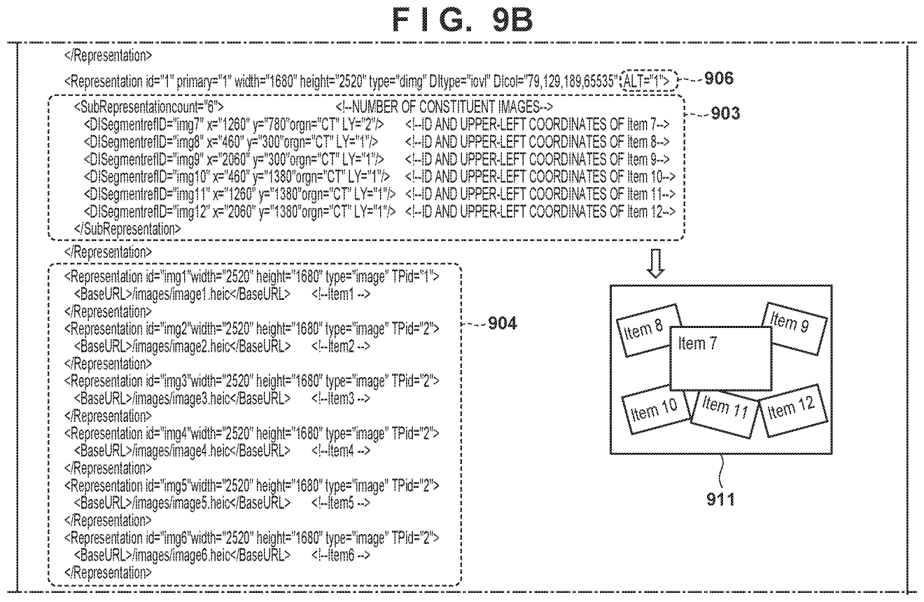

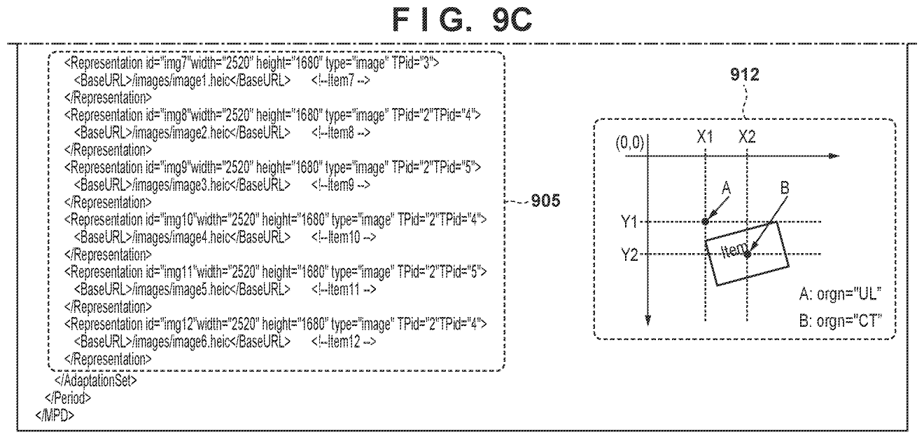

Next, as a third embodiment, a case where a plurality of layout information described in the first embodiment is defined will be described with reference to FIG. 9A-C. FIG. 9A-C are examples of a playlist generated in the transmission apparatus of the present embodiment, and is an example of a description of a case where a plurality of layout information is defined selectably.

In FIG. 9A-C, the playlist includes a transformation property 901, a constituent image 1 (904) and a constituent image 2 (905), and layout information 1 (902) and layout information 2 (903). Here, the transformation property 901 is information defining a plurality of transformation processes. The constituent image 1 (904) and the constituent image 2 (905) are images including a plurality of items to which the transformation properties are applied. The layout information 1 (902) and the layout information 2 (903) are information indicating two different layouts. The transformation property 901 stores information indicating geometric transformation processing such as enlargement/reduction and rotation, and a summary thereof is as described in the first embodiment. In addition, among the two sets of layout information and the constituent images described, the image used for the layout information 1 (902) is associated with the constituent image 1 (904) by referencing the Representation id. Similarly, the image used for the layout information 2 (903) is associated with the constituent image 2 (905).

However, although the method for defining the transformation type iscl parameter indicating enlargement/reduction has been described with a percentage in the description of the transformation property in the above first embodiment, the transformation property 901 may be described in a fraction format as illustrated in FIG. 9A. In the example of the description of FIG. 9A, the parameter of the first transformation type iscl indicates that the first numerical value 17 is the numerator and the next numerical value 28 is the denominator, and it is possible to describe the width and the height individually. Transformation processing associated by the identifier TPid is assigned as an attribute to each item in the constituent image 1 (904). Transformation processing is applied to the first item included in the constituent image 1 (904) to reduce it by 17/28 in both the vertical and horizontal directions, and transformation processing is applied to the other items to reduce them by 2/7 times in both the vertical and horizontal directions. Each item of the constituent image 1 (904) to which the reduction transformation processing is applied is arranged at the coordinates shown in the layout information 1 (902), and is displayed as an output image 1 (910).

Similarly, a transformation process is applied to the first item included in the constituent image 2 (905) to reduce it by 3/7 in both the vertical and horizontal directions. For the items other than the first item, after first applying the transformation processing for the 2/7 times reduction, a rotation process for a 15 degree counterclockwise rotation, or a rotation process for a 345 degree counterclockwise rotation (rotation by 15 degrees in a clockwise direction) is applied. Each item of the constituent image 2 (905) to which these transformation processes are applied is arranged according to coordinate information and the layer information indicated in the layout information 2 (903) which is associated by identifier.

Here, the layout information 2 (903) is given a layer attribute LY indicating the positional relationship of the superimposition of each item, and in the example of the description of FIG. 9B, the larger the numerical value set in the layer attribute LY is, the higher the layer is in the arrangement. That is, in the case where the layout information is information for an overlay-display of a plurality of media data, the overlay order of the layer-display is indicated by describing a numerical value representing the layer as an attribute value of each media data. In this example, the five items from Item 8 to Item 12 are in the same layer (LY=“1”), and Item 7 is arranged in an layer (LY=“2”) that is higher than that of these five items, and the result is displayed as an output image 2 (911).

For each item of the constituent image 1 (904) and each item of the constituent image 2 (905), a transformation process is performed based on respectively same items from image1.heic to image6.heic and then the layout-display is performed. The output image 1 (910) and the output image 2 (911) differ only partially in display size and layout; the content that is displayed is the same. That is, when there is a plurality of layout information including the same content in the playlist, the appropriate layout information may be selected to perform the display.

As described above, since it is possible to switch among the multiple layout information for the display in the case where the size and layout of the same content are different, the compatibility attribute 906 is described in FIG. 9B as attribute information for identifying the compatibility for switching. The compatibility attribute 906 is set to, for example, a numerical value, a character, or the like, such as ALT=“1”, and when a set numerical value, character, or the like is the same in multiple compatibility attributes 906, it indicates compatibility where switching therebetween is possible.

Such switchable layout information may be defined for a plurality of variations having different screen resolutions and aspect ratios, such as for a desktop PC, a smartphone, and a tablet PC, or for a portrait screen and a landscape screen. As the switchable layout information, a plurality of variations corresponding to differences in various operation methods such as a mouse operation, a touch screen operation, and a remote control operation may be defined. That is, a variety of variations of layout information may be defined in accordance with, for example, the resolution and aspect ratio of the screen; applicability to respective intended usage such as method of operation; communication environment; and user preferences. Further, in the layout information, in a case where a plurality of variations are defined, within the same display period, information for identifying variations that may be switched with each other within the display period may be defined.

Note that the layout information 2 (903) is described with orgn=“CT” as the coordinate origin of each item, and these indicate that the center of the item is the coordinate origin. Since a rotation transformation process is assigned to each item comprising the layout information 2 (903), as indicated in the item coordinate origin 912 of FIG. 9C, a virtual position is indicated by A (X1, Y1) focusing on the upper left coordinates, and the coordinates change depends on the rotational angle. Therefore, if B (X2, Y2), which is the center of the item, is set as the coordinate origin, the coordinate origin does not change even if the rotational angle is different, so it is easy to manage layout information.

### Fourth Embodiment

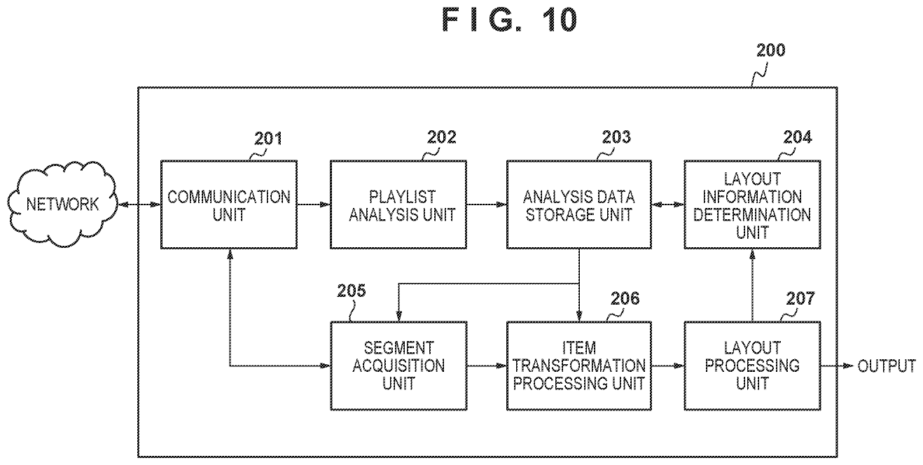

In the fourth embodiment, the information processing on an apparatus that received a playlist as described above will be described. FIG. 10 is a block diagram showing a functional configuration of the reception apparatus 200 shown in FIG. 1. The functional configurations of the information processing apparatus (reception apparatus 200) that receives the playlist described in the above-described first to third embodiments have similar configurations to those of FIG. 10. However, the reception apparatus 200, after acquiring a playlist as described in the first to third embodiments, performs reception-side information processing in accordance with transformation process information and layout information as described in the first to third embodiments.

That is, the reception apparatus 200 acquires a playlist including URLs for acquiring media data, analyzes the playlist, and receives media data using the result of the analysis of the playlist. Here, the playlist is generated by the transmission apparatus 100 of the above-described embodiment. Therefore, in the reception apparatus 200, in a case where the playlist includes transformation process information indicating one or more transformation processes to be applied to the received media data, transformation processing corresponding to the transformation process information is applied to the media data when the received media data is output. Here, for example, in a case where a plurality of the transformation process information are defined as media data attribute information, the reception apparatus 200 applies the transformation processing in the order in which the transformation process information is described in the playlist. When the media data is timed media, the reproduction period for each media is designated in the playlist, and in the case where the reproduction time is shorter than the reproduction period and the transformation process information indicates repetitive reproduction, the reception apparatus 200 repeats the reproduction of media data in the reproduction period.

Further, in the reception apparatus 200, in a case where the playlist includes one or more layout information for spatially arranging one or more media data and there are a plurality of layout information, one layout information is applied to the media data when the received media data is outputted. Further, for example, when a plurality of variations having different resolution or aspect ratio are defined in the layout information, at least one of the variations is applied in the reception apparatus 200. Also, for example, in a case where in the layout information, a plurality of variations corresponding to differences in method of operation of any of a mouse operation, a touch screen operation, a remote control operation, or the like are defined, the reception apparatus 200 applies at least one thereamong.

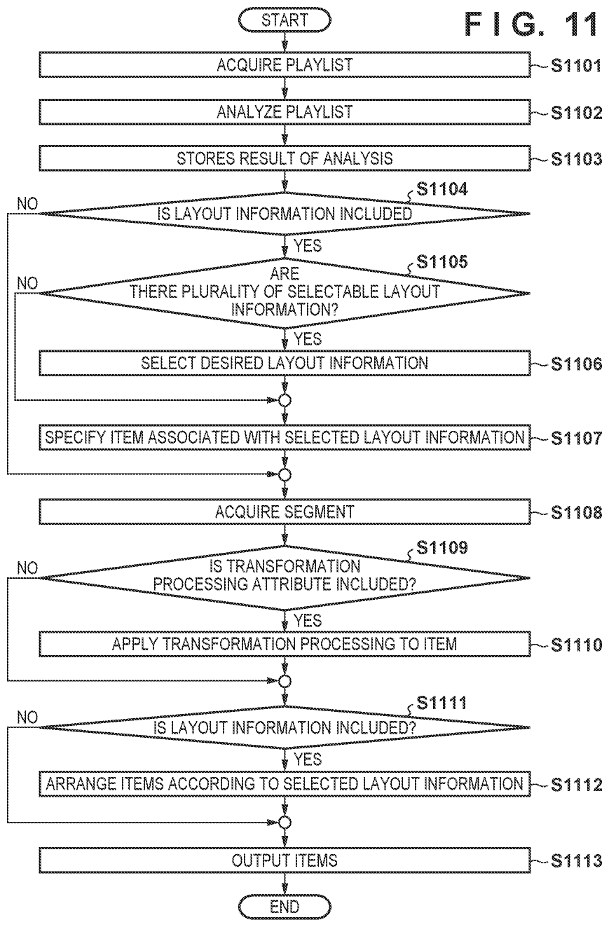

Although an example of a playlist in which a plurality of layout information are described is given in the above FIG. 9A-C, in the fourth embodiment, FIG. 10 and FIG. 11 will be used to describe information processing performed by the reception apparatus 200 after it acquires a playlist of the example of FIG. 9A-C.

First, a functional configuration of the reception apparatus 200 illustrated in FIG. 10 will be described.

As illustrated in FIG. 10, the reception apparatus 200 includes a communication unit 201, a playlist analysis unit 202, an analysis data storage unit 203, a layout information determination unit 204, a segment acquisition unit 205, an item transformation processing unit 206, and a layout processing unit 207.

The communication unit 201 has a playlist acquisition function for acquiring a playlist including a URL for acquiring media data transmitted from the transmission apparatus 100 via the network 150, and a segment reception function of receiving a segment.

The playlist analysis unit 202 analyzes the playlist received via the communication unit 201. The result of analyzing the playlist by the playlist analysis unit 202 is stored in the analysis data storage unit 203.

The layout information determination unit 204 has a function of determining whether layout information is included in the result of analyzing the playlist stored in the analysis data storage unit 203, and a function of selecting appropriate layout information from among a plurality of layout information.

The segment acquisition unit 205 extracts a still image item from the received segment.

The item transformation processing unit 206 applies transformation processing corresponding to the transformation process information for a still image item included in the analysis data stored in the analysis data storage unit 203 to the still image item extracted by the segment acquisition unit 205.

The layout processing unit 207 applies the layout selected by the layout information determination unit 204 to the still image item to which the transformation processing has been applied. The still image item to which the layout is applied by the layout processing unit 207 is displayed by an output apparatus such as a display.

FIG. 11 is a flowchart illustrating an example of processing, in the reception apparatus 200 according to the fourth embodiment, of a playlist in which a plurality of layout information are defined. A flow of processing in the reception apparatus 200 will be described below with reference to the flowchart of FIG. 11.

First, in step S1101, the communication unit 201 acquires a playlist from the transmission apparatus 100.

Next, in step S1102, the playlist analysis unit 202 performs a process for analyzing the playlist.

Next, in step S1103, the analysis data storage unit 203 stores the result of the analysis in step S1102.

Next, in step S1104, the layout information determination unit 204 refers to the analysis data stored in the analysis data storage unit 203, and first determines whether or not the layout information is included. If it is determined that the layout information is included, the layout information determination unit 204 advances the process to step S1105, and then determines whether there are a plurality of selectable layout information. In the case of determining that there are a plurality of selectable layout information items, the layout information determination unit 204 selects desired layout information in subsequent step S1106. After step S1106, the process in the reception apparatus 200 proceeds to step S1107.

On the other hand, if it is determined in step S1105 that there are not multiple selectable layout information, there is only one layout information, and therefore, naturally, the one layout information is selected, and the process of the reception apparatus 200 proceeds to step S1107.

When the process advances to step S1107, the layout information determination unit 204 specifies an item associated with the selected layout information.

Next, in step S1108, the segment acquisition unit 205 acquires a segment from the transmission apparatus 100 via the network by the communication unit 201 based on the result of analyzing the playlist.

Next, in step S1109, the item transformation processing unit 206 refers to the result of the analysis and determines whether a transformation processing attribute is included as an attribute of the acquired segment. If it is determined that the segment includes a transformation processing attribute, the item transformation processing unit 206 continues on to apply the transformation processing to the item in step S1110.

Next, in step S1111, the layout information determination unit 204 again determines whether or not layout information is included. When layout information is included, in the subsequent step S1112, the layout processing unit 207 arranges the items according to the selected layout information.

Thereafter, in step S1113, the layout processing unit 207 outputs the items subjected to the transformation processing and the layout arrangement to the display apparatus or the like.

In step S1106, similar criteria to that described in the third embodiment may be used as the determination criteria when the layout information determination unit 204 selects desired layout information from among the plurality of layout information. That is, a plurality of variations such as specifications of resolution, aspect ratio, or the like of a display device for output; communication environment; or the like are defined, and appropriate layout information may be selected in accordance with these variations, or may be arbitrarily selected by a user.

As described above, in the embodiment, the playlist includes at least one of transformation process information representing one or more transformation processes to be applied to the media data and one or more layout information for spatially arranging the media data. Also, the playlist is made to be an MPEG-DASH MPD (Media Presentation Description). The transformation process information is defined as attribute information of the media data. Also, when a plurality of transformation processes are applied to single media data, transformation process information is described in the playlist in the order in which the transformation processes are to be applied. For example, when the media data is a still image or a moving image, transformation process information is information indicating that geometric transformation processing is to be performed on the media data. Further, for example, when the media data is audio data, the transformation process information is information indicating that the volume or the sound pressure of the media data is to be changed, or is information indicating that a part of the frequency band of the media data is to be extracted. That is, in a case where the media data is timed media having temporal data, for example, the transformation process information may be information indicating that a part of the section on the time axis of the media data is to be extracted. Also, when the media data is timed media, for example, the reproduction period for each media data is designated in the playlist and the reproduction time of the media data is shorter than the reproduction period, the transformation process information may be information indicating that the reproduction of media data is repeated in the reproduction period. Further, the layout information may be information in which a plurality of variations having different resolutions or aspect ratios are defined. As the layout information, a plurality of variations corresponding to differences in an operation method of any of a mouse operation, a touch screen operation, or a remote control operation may be defined. Further, for example, in the layout information, in a case where a plurality of variations are defined within the same display period, information for identifying variations that may be switched with each other within the display period may be defined. Further, for example, the layout information may be information for an overlay-display of a plurality of media data. In this case, the layout information indicates an overlay order of a layer-display according to including at least one of an order in which media data to be overlay-displayed are described and a description of a numerical value representing a layer as the attribute value of respective media data.

According to the above-described embodiments, in transmission/reception of streaming, such as MPEG-DASH, it is possible to perform a transformation process such as enlargement/reduction/rotation of a segment transmitted by streaming and then performing a layout-display.

Note that even in above-mentioned Japanese Patent Laid-Open No. 2011-172255, metadata for performing a geometric transformation on a video and an overlay-display is described in a playlist. However, the technique described in Japanese Patent Laid-Open No. 2011-172255 does not disclose the inclusion in the playlist of one or more substitutable layout information (which need not include an overlay) or patterns for application of transformation process attributes, as does the present embodiment. Thus, in Japanese Patent Laid-Open No. 2011-172255, the layout cannot be dynamically changed in accordance with the processing capability of the client, the execution environment, the preference of the user, and the like, as it can in the present embodiment. In addition, Japanese Patent Laid-Open No. 2011-172255 does not disclose a description method (application order) for a playlist (MPD) in a case where a plurality of transformation process attributes are applied thereto, or a method for describing an overlay layer configuration, audio scaling, and cropping, or the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-184747, filed Nov. 12, 2021, which is hereby incorporated by reference herein in its entirety.

What is claimed is:

1. An information processing apparatus, comprising:
a processor; and
a memory storing executable instruction which, when executed by the processor, cause the information processing apparatus to perform operations including:
generating a playlist including a URL (Uniform Resource Locator) for acquiring media data;
transmitting the media data and the playlist, wherein
the playlist includes at least one of transformation process information which indicates one or more transformation processes to be applied to the media data, and one or more layout information for spatially arranging the media data.

2. The information processing apparatus according to claim 1, wherein the transformation process information is defined as attribute information of the media data.

3. The information processing apparatus according to claim 1, wherein in a case where a plurality of transformation processes are to be applied to one media data, the transformation process information is described in an order in which the transformation processes are to be applied in the playlist.

4. The information processing apparatus according to claim 1, wherein in a case where the media data is a still image or a moving image, the transformation process information is information indicating that geometric transformation processing is to be performed on the media data.

5. The information processing apparatus according to claim 1, wherein in a case where the media data is audio data, the transformation process information is information indicating that a volume or a sound pressure of the media data is to be changed.

6. The information processing apparatus according to claim 1, wherein in a case where the media data is audio data, the transformation process information is information indicating that a part of a frequency band of the media data is to be extracted.

7. The information processing apparatus according to claim 1, wherein in a case where the media data is timed media having temporal data, the transformation process information is information indicating that a section on a time axis of the media data is to be extracted.

8. The information processing apparatus according to claim 1, wherein in a case where the media data is timed media having temporal data, there is a plurality of the media data in the playlist, a reproduction period is designated for each of the media data in the playlist, and a reproduction time of the media data is shorter than the reproduction period, the transformation process information is information indicating that reproduction of the media data is to be repeated in the reproduction period.

9. The information processing apparatus according to claim 1, wherein in the layout information, a plurality of variations having different resolution or aspect ratio are defined.

10. The information processing apparatus according to claim 1, wherein in the layout information, a plurality of variations corresponding to differences in an operation method of any of a mouse operation, a touch screen operation, and a remote control operation are defined.

11. The information processing apparatus according to claim 1, wherein in a case where a plurality of variations are defined in a same display period in the layout information, information for identifying variations that are switchable with each other in the display period is included.

12. The information processing apparatus according to claim 1, wherein in a case where the layout information is information for an overlay display of a plurality of media data, an overlay order of a layer display is indicated by at least one of: an order in which media data to be overlay-displayed are described, and a description of a numerical value representing the layer as an attribute value of each media data.

13. An information processing apparatus, comprising:
a processor; and
a memory storing executable instruction which, when executed by the processor, cause the information processing apparatus to perform operations including:
generating a playlist including a URL (Uniform Resource Locator) for acquiring media data; and
transmitting the media data and the playlist, wherein
URLs for acquiring a plurality of media data are described in the playlist, and among the plurality of media data, content of first media data is a derived operation corresponding to second media data,
the playlist includes information indicating that the first media data is a derived operation of another media data and information for identifying that a target of a derived operation of the first media data is the second media data,
the derived operation includes at least one of transformation process information indicating one or more transformation processes to be applied to the second media data and one or more layout information for spatially arranging the second media data.

14. An information processing apparatus, comprising:
a processor; and
a memory storing executable instruction which, when executed by the processor, cause the information processing apparatus to perform operations including:
acquiring a playlist including a URL (Uniform Resource Locator) for acquiring media data; and
analyzing the playlist;
receiving the media data by using a result of the analysis of the playlist, wherein
in a case where the playlist includes transformation process information indicating one or more transformation processes to be applied to the received media data, when outputting the received media data, the transformation processes indicated in the transformation process information is applied to the media data.

15. The information processing apparatus according to claim 14, wherein the transformation process information is defined as attribute information of the media data.

16. The information processing apparatus according to claim 14, wherein in a case where a plurality of transformation process information is defined as attribute information in the media data, the transformation processes are applied in order of description of transformation process information in the playlist.

17. The information processing apparatus according to claim 14, wherein in a case where the media data is timed media having temporal data, a reproduction period is designated for each of the media data in the playlist, and a reproduction time of the media data is shorter than the reproduction period, in a case where the transformation process information is information indicating that reproduction of the media data is to be repeated, reproduction of the media data is repeated in the reproduction period.

18. A information processing apparatus, comprising:
a processor; and
a memory storing executable instruction which, when executed by the processor, cause the information processing apparatus to perform operations including:
acquiring a playlist including a URL (Uniform Resource Locator) for acquiring media data;
analyzing the playlist;
receiving the media data by using a result of the analysis of the playlist, wherein
in a case where the playlist includes one or more layout information for spatially arranging one or more media data and there are a plurality of layout information, one layout information is applied to the media data when the received media data is outputted.

19. The information processing apparatus according to claim 18, wherein in a case where a plurality of variations having different resolution or aspect ratio are defined in the layout information, at least one of the variations is applied.

20. The information processing apparatus according to claim 18, wherein in the layout information, a plurality of variations corresponding to differences in an operation method of any of a mouse operation, a touch screen operation, and a remote control operation are defined, at least one variation is applied.

21. The information processing apparatus according to claim 1, wherein the playlist is an MPEG-DASH (Moving Picture Experts Group—DynamicAdaptive Streaming over HTTP) MPD (Media Presentation Description).

22. An information processing method, comprising:
generating a playlist including a URL (Uniform Resource Locator) for acquiring media data;
transmitting the media data and the playlist, wherein
the playlist includes at least one of transformation process information which indicates one or more transformation processes to be applied to the media data, and one or more layout information for spatially arranging the media data.

23. An information processing method, comprising:
generating a playlist including a URL (Uniform Resource Locator) for acquiring media data; and
transmitting the media data and the playlist, wherein
URLs for acquiring a plurality of media data are described in the playlist, and among the plurality of media data, content of first media data is a derived operation corresponding to second media data,
the playlist includes information indicating that the first media data is a derived operation of another media data and information for identifying that a target of a derived operation of the first media data is the second media data,
the derived operation includes at least one of transformation process information indicating one or more transformation processes to be applied to the second media data and one or more layout information for spatially arranging the second media data.

24. An information processing method, comprising:
acquiring a playlist including a URL (Uniform Resource Locator) for acquiring media data; and
analyzing the playlist;
receiving the media data by using a result of the analysis of the playlist, wherein
in a case where the playlist includes transformation process information indicating one or more transformation processes to be applied to the received media data, when outputting the received media data, the transformation processes indicated in the transformation process information is applied to the media data.

25. An information processing method, comprising:
acquiring a playlist including a URL (Uniform Resource Locator) for acquiring media data;
analyzing the playlist;
receiving the media data by using a result of the analysis of the playlist, wherein
in a case where the playlist includes one or more layout information for spatially arranging one or more media data and there are a plurality of layout information, one layout information is applied to the media data when the received media data is outputted.

26. A non-transitory computer-readable storage medium storing a program that, when executed by a computer, causes the computer to perform an information processing method, the method comprising:
generating a playlist including a URL (Uniform Resource Locator) for acquiring media data;
transmitting the media data and the playlist, wherein
the playlist includes at least one of transformation process information which indicates one or more transformation processes to be applied to the media data, and one or more layout information for spatially arranging the media data.
